(19) United States
(12) Patent Application Publication
(10) Pub. No.: US 2005/0268073 A1
(43) Pub. Date: Dec. 1, 2005

(54) Critical section availability

(75) Inventor: Alan Hersh Karp, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/853,364

(22) Filed: May 25, 2004

(51) Int. Cl. G06F 12/00; G06F 9/00

(52) U.S. Cl. 712/207; 712/228; 711/206

(57) ABSTRACT

Availability of a critical section is determined according to a state associated with an address table entry and a speculative instruction.

### BACKGROUND INFORMATION

Some programs are designed so that only a single process or thread can access a particular series of computer instructions at a given time. Thus, once a process or thread has been granted access, all other processes and/or threads must be excluded until the process that has access relinquishes it. The region of code where a process has exclusive access is sometimes known to those of skill in the art as a critical section. While various mechanisms have been designed to limit access to a critical section during execution by a selected process or thread, their use may result in generating additional memory traffic, increased cache usage or line invalidation, and the need for specialized support hardware.

### BRIEF DESCRIPTION OF THE DRAWINGS

FIG. 1 is a block diagram of an apparatus and a system according to various example embodiments;

FIG. 2 includes flow diagrams illustrating several methods according to various example embodiments; and

FIG. 3 is a block diagram of an article according to various example embodiments.

### DETAILED DESCRIPTION

For the purposes of this document, an “address table” may comprise a memory structure capable of storing or referencing one or more addresses, or indications of addresses, including syndromes, corresponding to some operational aspect of an instruction, such as executing one or more instructions with respect to a variable, including executing speculative instructions (e.g., speculative load instructions). When at least one location in an address table is used to provide an indication of the status of an entry associated with a speculative instruction, and/or a variable upon which the instruction operates, the address table may comprise an “advanced load address table” (ALAT). An example of an ALAT is a structure similar to or identical to the ALAT associated with the Intel® Itanium® IA-64 processor.

The terms “available” or “availability”, with reference to a critical section, means that the critical section is available for execution by a process, including one or more threads of control, requesting access to the critical section, or that some attempt may be made to determine the availability (i.e., whether the critical section is available) for execution.

The phrase “critical section” means a section of computer-executable code comprising at least one instruction that is designed to be executed by one process, including one or more threads of control, at a time.

An “energy conduit” includes any type of device or apparatus that has the capability to transmit and/or receive energy to and/or from space. Examples of such energy conduits include antennas (e.g., monopole, patch, omnidirectional, etc.), infra-red transmitters, infra-red receivers, infra-red transceivers, photo-emitters (e.g., light emitting diodes), photo-receptors (e.g., a photocell), and charge-coupled devices, among others.

A “process” is a module (e.g., comprising hardware, software, or both) or a series of instructions, including one or more threads of control, capable of causing a critical section to execute, such as by requesting access to the critical section, asserting an interrupt, or calling the critical section as a subroutine, for example.

A “speculative instruction” is an instruction that permits an operation to be scheduled for execution prior to one or more related operations that may be ambiguous relative to the scheduled operation. For example, a “speculative load instruction” is an instruction that permits a load operation to be scheduled for execution prior to one or more store operations that may be ambiguous relative to that load operation. An example of a speculative load instruction is an instruction that is similar to or identical to the “ld.a” instruction that can be executed by the Intel® Itanium® IA-64 processor.

A “state”, with reference to an entry in an address table corresponding to an instruction, refers to the status of the entry. For example, a speculative load instruction may have corresponding entries in an address table which are either present (e.g., as evidenced by an entry in an ALAT), or not present (e.g., no corresponding entry in the ALAT), perhaps with respect to a particular variable.

The term “transceiver” (e.g., a device including a transmitter and a receiver) may be used in place of either “transmitter” or “receiver” throughout this document. Thus, anywhere the term transceiver is used, “transmitter” and/or “receiver” may be substituted.

Mutual exclusion is a way of synchronizing computer code execution to ensure that when one process is granted access to a critical section, other processes will be excluded from doing the same thing. Approaches to mutual exclusion include disabling interrupts, locking variables, and strict alternation. Some approaches may utilize special instructions, including variations of the testandset instruction, for example. However, these mechanisms can increase memory bus traffic, since memory variable values may be read and written as part of the procedure. Other less than desirable effects may include increased cache usage, a rise in the amount of cache line invalidation, and the need for special support hardware, such as specialized registers.

Consider the following sequence of instructions, for example:
c: testandset a,0,c
{critical section}
a=1
   Here the variable “a” has been defined as a lock, and the testandset instruction results in continuous branching back to the “c” instruction when a=0 (i.e., when the lock is set).

When a=1, this means the lock has been released, and the critical section is available for execution by a requesting process. Thus, when the lock is released, a process executing this testandset instruction will cause the value of “a” to be set to “0”, locking the critical section (i.e., the lock is set). And, instead of branching back to the “c” instruction, the critical section is then executed. The value of “a” may then be set to “1”, releasing the lock. Unfortunately, memory bus traffic may be generated using this mechanism since the variable “a” is set and cleared each time the critical section executes.

In some embodiments, an advanced load of the lock variable “a” may be used to release the lock, resulting in the address of “a” being entered into a pre-existing address table, such as an ALAT. Consider the following sequence of instructions:
c: chk.a.clr a,c
{critical section}
ld.a a
   Here the actual value of the variable “a” is not used. The speculative instruction ld.a is used to put an entry into the address table (i.e., the state of the entry is “present”). The chk.a.clr instruction is used to remove the entry from the table (i.e., the state of the entry is “not present”).

If there is no corresponding entry in the ALAT, the instruction chk.a.clr will result in continuous branching to the “c” instruction until the lock is released (e.g., an advanced load of “a” is executed by another process). Once the lock is released, the chk.a.clr instruction may operate to atomically clear the ALAT entry for the variable “a” (to set the lock), the critical section may be executed, and then a speculative instruction, such as a speculative load instruction (e.g., ld.a), may be executed to release the lock.

In some embodiments, executing a speculative instruction, such as a speculative load instruction, may result in making an entry to the ALAT that can be checked without generating memory bus traffic. In some embodiments, an indicator, such as a bit, may be used to denote that a particular address table entry, such as an ALAT entry, is part of a process state to be saved and restored across context switches, such that the table entry may not be replaced, but only explicitly cleared. This indicator may be used to indicate that the address table entry may not be removed to make room for other entries (as may occur when an ALAT is used in a conventional fashion).

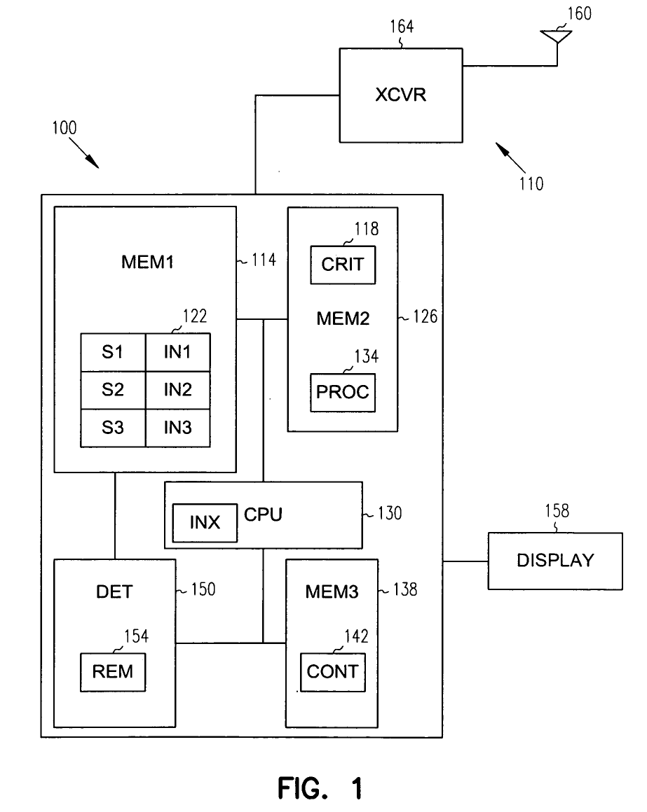

FIG. 1 is a block diagram of an apparatus 100 and a system 110 according to various, example embodiments, each of which may operate in the manner described above. For example, an apparatus 100 may comprise a memory 114 capable of storing or indicating at least one state S1 of an address table entry associated with a speculative instruction INX to indicate the availability of a critical section 118. In some embodiments, the memory 114 may be physically located very close to an associated processor, or even included as part of the processor (e.g., processor 130, below). Thus, the apparatus 100 may include a structure 122, perhaps included in the memory 114, comprising a table (e.g., an address table, including an ALAT) and/or one or more registers, capable of storing and/or indicating a plurality of states S1, S2, S3 associated with one or more address table entries and a corresponding plurality of speculative instructions (e.g., several instructions including the speculative instruction INX). The states S1, S2, S3 may include or be associated with at least a portion of an address, such as a syndrome associated with a speculative load variable (e.g., part of an address associated with the variable “a” of a “ld.a a” instruction).

In some embodiments, the apparatus 100 may include one or more indicators IN1, IN2, IN3 (associated with the states S1, S2, S3) to indicate whether one or more address table entries (e.g., corresponding to the presence or absence of entries in the table) are part of a process state to be saved and restored across context switches. The indicators IN1, IN2, IN3 may comprise one or more bits to indicate whether address table entries and/or the states S1, S2, S3 are to be saved and restored across context switches. The apparatus 100 may include a second memory 126, to be coupled to a processor 130, to store instructions associated with a process 134 capable of accessing the critical section 118.

The apparatus 100 may also include a memory structure 138 to store a context 142. The context 142, in turn, may include one or more advanced load address table entries (e.g., states S1-S3 and/or indicators IN1-IN3) associated with a process 134 capable of executing, accessing, or causing a critical section 118 to execute.

In some embodiments, an apparatus 100 may include a memory 114 capable of storing or indicating one or more states S1-S3 of one or more address table entries associated with one or more speculative instructions INX to indicate the availability of a critical section 118, perhaps across a plurality of context switches. The apparatus 100 may include a means 150 to determine the states S1-S3. The means 150 may be present in any number of forms, such as a processor 130, or any other hardware (e.g., dedicated logic), firmware, and/or software capable of implementing an instruction to check for the presence or absence of an entry in an address table 122 associated with the states S1-S3, for example. In some embodiments, the memory 114 may be physically located very close to the processor 130, and the means 150 may form a portion of the memory 114. The apparatus 100 may further include means 154 to atomically remove an entire address table entry associated with the state, such as states S1-S3. Other embodiments may be realized.

For example, a system 110 may include an apparatus 100 as described above (e.g., a memory 114 capable of storing one or more states S1-S3 of one or more address table entries associated with one or more speculative instructions INX to indicate availability of a critical section 118; and a processor 130 capable of accessing the memory 114). The apparatus 100 may be coupled to a display 158, as well as an energy conduit 160 to transmit data 118 processed by the processor 130.

In some embodiments, the system 110 may include a transceiver 164 to couple the processor 130 to the energy conduit 160. The system 110 may include means (e.g., indicators IN1-IN3) to indicate whether one or more address table entries are part of a process state to be saved and restored across context switches. While not shown, it is to be understood that a system 110 may also include multiple processors, similar to or identical to processor 130, and each processor 130 may be associated with a separate address table 122, including an ALAT.

The apparatus 100, system 110, memories 114, 126, critical section 118, structure 122, processor 130, process 134, memory structure 138, context 142, means 150, 154, display 158, energy conduit 160, transceiver 164, instruction INX, indicators IN1-IN3, and states S1-S3 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100 and the system 110, and as appropriate for particular implementations of various embodiments. The memories 114, 126, and the memory structure 138 may be combined into a single module or device, or separated into multiple modules/devices, as desired.

It should also be understood that the apparatus and systems of various embodiments can be used in applications other than transmitters and receivers, and other than for wireless systems, and thus, various embodiments are not to be so limited. The illustrations of an apparatus 100 and system 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, personal digital assistants (PDAs), workstations, radios, video players, vehicles, and others.

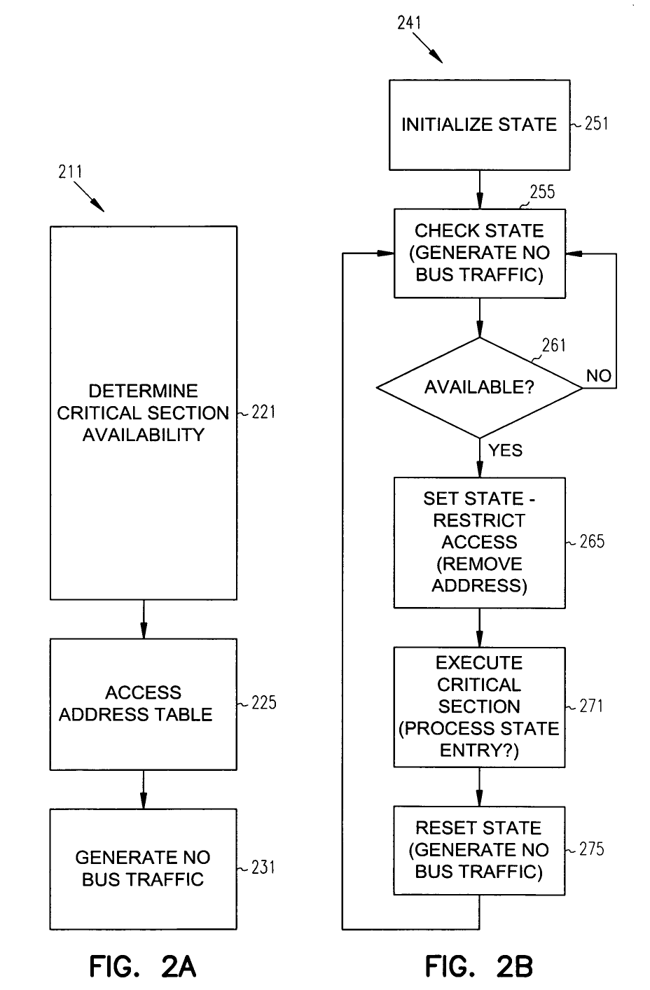

FIG. 2 includes flow diagrams illustrating several methods according to various example embodiments. In some embodiments, a method 211 may (optionally) begin with determining the availability of a critical section according to the state of an address table entry associated with a speculative instruction (and/or a variable upon with the speculative instruction operates) at block 221. The speculative instruction may comprise any number of instructions, including a speculative load instruction, for example. Among others, the state may be selected from one of present and not present, as noted above.

In some embodiments, the method 211 may include accessing an address table to determine the state of the address table entry at block 225. The address table may comprise an ALAT. The method may include determining the availability without generating memory traffic on a bus at block 231. This may occur in a number of ways, including checking an address table entry, such as an ALAT entry, without referencing the actual value of an associated variable stored in memory.

In some embodiments, a method 241 may (optionally) begin with initializing the state of a speculative instruction by executing the speculative instruction at block 251. The speculative instruction may comprise any number of instructions, including a speculative load instruction. The method 241 may include repeatedly checking for an indication of an address table entry (e.g., an ALAT entry) at block 255, wherein the indication is associated with a state of the address table entry associated with the speculative instruction (and/or a variable upon which the speculative instruction operates). Thus, the method 241 may also include determining the state of the address table entry without generating memory traffic on a bus, such as a memory bus, at block 255.

If the state of the address table entry indicates the critical section is available at block 261, then the method 241 may include restricting access to the critical section by clearing an entry in an address table, perhaps comprising an ALAT, at block 265. This may be accomplished, for example, by atomically removing an address associated with a speculative instruction from the address table. If the state of the speculative instruction indicates that access to the critical section will not be granted (e.g., access has been restricted to a single process) at block 261, then the method 241 may continue with checking the state of the address table entry at block 255.

In some embodiments, the method 241 may include exclusively executing the critical section associated with the state upon determining the address table entry has a state of “not present” at block 271. It should be noted that in this case, as in others described throughout this document, exclusive execution means that a process may have multiple threads of control, but only one thread of control at a time can be active in a critical section, whether they're from the same process or different processes. In some embodiments, the method 241 may also include accessing an indication associated with the critical section to determine whether the address table entry is part of a process state to be saved and restored across context switches at block 271, or at any other point in the methods 211 and 241. The accessed indication may comprise one or more bits included in a memory. In some embodiments, the method 241 may include changing the state of the address table entry (e.g., making an entry in the table, or clearing an entry in the table), perhaps without generating memory traffic on a bus, such as a memory bus, at block 275.

It should be noted that the methods described herein do not have to be executed in the order described, or in any particular order. Moreover, various activities described with respect to the methods identified herein can be executed simultaneously, and/or in serial or parallel fashion. For the purposes of this document, the terms “information” and “data” may be used interchangeably. Information, including parameters, commands, operands, instructions, and other data, can be sent and received in the form of one or more carrier waves.

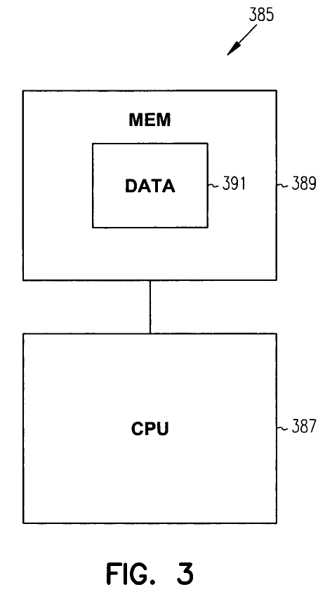

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well-known to those skilled in the art, such as application program interfaces or inter-process communication techniques, including semaphores and remote procedure calls. The teachings of various embodiments are not limited to any particular programming language or environment. Thus, other embodiments may be realized, as shown in FIG. 3.

FIG. 3 is a block diagram of an article 385 according to various example embodiments, such as a computer, a memory system, a magnetic or optical disk, some other storage device, and/or any type of electronic device or system. The article 385 may comprise a processor 387 coupled to a machine-accessible medium such as a memory 389 (e.g., a memory including an electrical, optical, or electromagnetic conductor) having associated information 391 (e.g., computer program instructions, and/or other data), which when accessed, results in a machine (e.g., the processor 387) performing such actions as determining the availability of a critical section according to the state of an address table entry associated with a speculative instruction. Other activities may include restricting access to the critical section by clearing an entry in an address table, which may comprise an ALAT. Further activities may include determining the state of the address table entry without generating memory traffic on a bus (e.g., a memory bus), as well as changing the state of the speculative instruction without generating memory traffic on a bus. It may now be understood in light of this disclosure that such activities may also include, for example, repeatedly checking for an indication of an address table entry, wherein the indication is associated with a state of the address table entry.

Implementing the apparatus, systems, and methods described herein may result in providing a mechanism for protecting critical section execution without generating additional memory bus traffic. Further, such protection may be maintained across a plurality of context switches.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments of the invention have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method, including:
determining availability of a critical section according to a state of an address table entry associated with a speculative instruction.

2. The method of claim 1, wherein the speculative instruction comprises a speculative load instruction.

3. The method of claim 1, wherein the state is selected from one of present and not present.

4. The method of claim 1, further including:
accessing an address table to determine the state of the address table entry.

5. The method of claim 4, wherein the address table comprises an advanced load address table.

6. The method of claim 1, further comprising:
determining the availability without generating memory traffic on a bus.

7. A method, including:
repeatedly checking for an indication of an address table entry, wherein the indication is associated with a state of the address table entry associated with a speculative instruction; and
exclusively executing a critical section associated with the state upon determining the address table entry is present.

8. The method of claim 7, wherein the speculative instruction comprises a speculative load instruction.

9. The method of claim 7, further including:
atomically removing an address table entry associated with the speculative instruction from the address table.

10. The method of claim 7, further including:
accessing an indication associated with the critical section to determine whether the address table entry is part of a process state to be saved and restored across context switches.

11. The method of claim 10, wherein the indication comprises at least one bit in a memory.

12. The method of claim 7, further comprising:
initializing the state of the address table entry by executing the speculative instruction.

13. An article including a machine-accessible medium having associated information, wherein the information, when accessed, results in a machine performing:
determining availability of a critical section according to a state of an address table entry associated with a speculative instruction.

14. The article of claim 13, wherein the information, when accessed, results in the machine performing:
restricting access to the critical section by clearing the entry in the address table.

15. The article of claim 14, wherein the address table comprises an advanced load address table.

16. The article of claim 13, wherein the information, when accessed, results in the machine performing:
changing the state of the address table entry without generating memory traffic on a bus.

17. The article of claim 13, wherein the information, when accessed, results in the machine performing:
determining the state of the address table entry without generating memory traffic on a bus.

18. The article of claim 17, wherein the information, when accessed, results in the machine performing:
repeatedly checking for an indication of an address table entry, wherein the indication is associated with a state of the address table entry.

19. An apparatus, including:
a memory capable of storing a state of an address table entry associated with a speculative instruction to indicate availability of a critical section across a plurality of context switches.

20. The apparatus of claim 19, further including:
a structure selected from one of a table and a register capable of indicating a plurality of states associated with a plurality of address table entries and a corresponding plurality of speculative instructions including the speculative instruction.

21. The apparatus of claim 19, further including:
an indicator associated with the state to indicate whether an address table entry is part of a process state to be saved and restored across the plurality of context switches.

22. The apparatus of claim 19, further including:
a second memory to be coupled to a processor and to store instructions associated with a process to access the critical section.

23. The apparatus of claim 19, wherein the state is associated with at least a portion of an address.

24. The apparatus of claim 19, further including:
a memory structure to store a context, including an advanced load address table entry, associated with a process capable of executing the critical section.

25. A system, including:
a memory capable of storing a state of an address table entry associated with a speculative instruction to indicate availability of a critical section across a plurality of context switches;
a processor capable of accessing the memory; and
an energy conduit to transmit data processed by the processor.

26. The system of claim 25, further including:
a transceiver to couple the processor to the energy conduit.

27. The system of claim 25, further including:
means to indicate whether the address table entry is part of a process state to be saved and restored across the plurality of context switches.

28. The system of claim 25, wherein the energy conduit is selected from one of an omnidirectional antenna and an infra-red transceiver.

29. An apparatus, including:
a memory capable of storing a state of an address table entry associated with a speculative instruction to indicate availability of a critical section across a plurality of context switches; and
means to determine the state.

30. The apparatus of claim 29, wherein the means to determine the state includes hardware capable of implementing an instruction to check for the presence of the address table entry.

31. The apparatus of claim 29, further including:
means to atomically remove the address table entry.
